(19) United States
(12) Patent Application Publication
(10) Pub. No.: US 2008/0242324 A1
(43) Pub. Date: Oct. 2, 2008

(54) Efficient message communication in mobile browsers with multiple endpoints

(75) Inventors: Michael Adam Smuga, Seattle, WA (US); Andre Oliver Michael Mohr, Seattle, WA (US); Sandra G. Hirsh, Palo Alto, CA (US); Lu Ge, Shenzhen (CN); Christine Anderson, San Jose, CA (US); Zen Fan, Shenzhen (CN)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/729,616

(22) Filed: Mar. 28, 2007

(51) Int. Cl. H04Q 7/20

(52) U.S. Cl. 455/466

(57) ABSTRACT

Described is a technology directed towards providing a single page of data that when rendered (e.g., on a mobile device) displays combined content from multiple endpoints (e.g., corresponding to different messaging participants). Interaction with the page facilitates communication back to each endpoint. Bidirectional communication logic such as a messaging application provides the interactive page as a user interface. Content corresponding to each conversation is displayed in a separate area, which may include an interactive mechanism (e.g., a text input area and send mechanism) for sending a message to the messaging participant associated with that conversation. When content changes (e.g., following a page refresh), a change indication may be provided, such as by displaying a notification banner, and/or by changing the appearance (e.g., color) of changed message content. A page collapsing mechanism may limit the content displayed on the single page, such as based on a maximum number of messaging conversations.

### BACKGROUND

A key problem with interacting with mobile web pages on mobile phones is the time it takes for the device to complete the download operation of each page, from the time the user selects a link to the time when the page is fully downloaded. This is primarily because mobile networks are relatively slow, devices frequently suspend connections preserve battery life, and mobile connections are unreliable.

To download a single page, a mobile device has to establish a network connection, locate the server, request the page and download the page. Establishing the connection, locating the server and requesting the page can take a relatively long time, sometimes exceeding fifty percent of the overall download time.

When dealing with messaging applications in which a user interacts with a page's content and may communicate with multiple users, the overall loading time can be significant. For example, consider a mobile user that already has a messaging conversation taking place with two users, User A and User B, in which messages are being exchanged. To view a message received from user A requires one page load, and to respond with a message to user A requires another page load after submitting the message. To then view a message received from user B requires one more page load, and to respond with a message to user B requires another page load after submitting the message to user B. Therefore, to exchange one full round of messages with two users, the user's device is required to perform four page loads; two full rounds of messages with two users would take eight page loads, and so forth. This is time-consuming and frustrating to users.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards providing a single page of data that when rendered displays combined content from multiple endpoints (e.g., corresponding to messaging participants) on a single page, and allows for separate communication back to each endpoint via interaction with that page. Bidirectional communication logic such as a messaging application is coupled to the display and input mechanism of a computing device such as a mobile device. The bidirectional communication logic provides a user interface that displays content received from at least two endpoints in a single page, and provides for user interaction with the single page to selectively communicate data to any of the endpoints.

In one example messaging implementation, a page collapsing mechanism limits the message content displayed on the single page, such as based on a number of conversations. In one example messaging implementation, content corresponding to each conversation is displayed in a separate area, which includes an interactive mechanism (e.g., a text input area and a send mechanism) for sending a message to the messaging participant associated with that conversation. In one example messaging implementation, at least one indication when message content has changed relative to previously displayed message content is provided, such as by providing a notification indication such as a banner, and/or by changing the appearance (e.g., color) of message content that has changed.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram generally representing an example of a mobile device that is configured for receiving multiple message content from a server, with the message content combined into a single interactive page.

FIG. 2 is a block diagram generally representing an example server that routes content between endpoints, including content combined into a single interactive page for at least one of the endpoints.

FIGS. 3-5 are representations of rendered page content corresponding to a single messaging page having content of multiple conversations, with new messaging content being received relative to previously received messaging content.

FIG. 6 is a flow diagram showing example steps taken by a server and/or a messaging application to provide page content corresponding to a single messaging page that has message content corresponding to multiple conversations.

### DETAILED DESCRIPTION

Various aspects of the technology described herein are generally directed towards a messaging framework, including a messaging service and a messaging application that runs in mobile web browsers. The messaging service and application allows the user to communicate with multiple users from one page, instead of loading multiple pages (e.g., one page for communicating with each different user).

In one example implementation, Windows® Messenger is represented as the messaging service and application, however it will be understood that this is only an example, and that the various concepts and aspects described herein are not limited to any particular service and/or application. Further, while the messaging application provides significant benefits with mobile browsers that render messaging content as a page, the various concepts and aspects described herein apply to any type of endpoint device capable of receiving and outputting messaging content, including a personal computer or other communications device.

As such, the present invention is not limited to any particular embodiments, aspects, concepts, protocols, structures, mechanisms, algorithms, functionalities or examples described herein. Rather, any of the embodiments, aspects, concepts, protocols, structures, mechanisms, algorithms, functionalities or examples described herein are non-limiting, and the present invention may be used various ways that provide benefits and advantages in computing and user interface navigation in general.

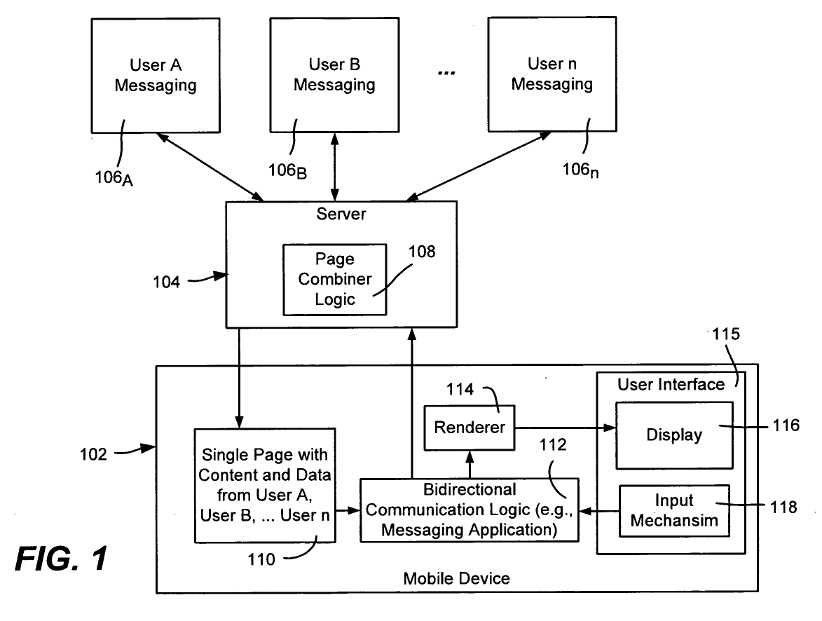

Turning to FIG. 1, there is shown an example representation of a messaging framework in which a mobile device 102 receives messages as page content via a messaging service represented via a server 104. The mobile device may receive messages from any number of other users at any given time; three such other users 106_{A}-106ₙ are shown in FIG. 1, but as can be appreciated, any practical number of other users may be communicating at a given time.

As described below, page combiner logic 108 combines the messaging (or other) content from the various other users into a data comprising a single page 110 received at the mobile device 102. A bidirectional communication mechanism exemplified in FIG. 1 as a messaging application 112, in conjunction with a renderer 114, provides a user interface 115 that outputs the page content to the device's display 116. An input mechanism 118 is also shown as part of the user interface 115, by which the mobile device 102 can selectively send content (e.g., messages) to each of the other users via the server 104, and also perform actions such as requesting of the server 104 a refreshing of the page content 110.

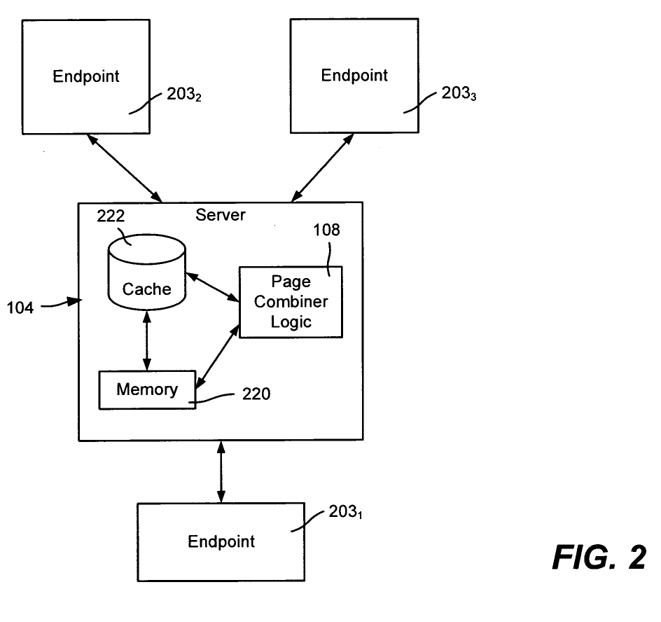

FIG. 2 represents components of the exemplified server 104 that couple endpoints (three such endpoints 203₁-203₃ are shown, but any practical number may be presently using the server's service) to one another. Note that in typical messaging applications, each of the endpoints are configured for bi-directional communication, but are not necessarily mobile devices. For example, a user at one endpoint may be running a messaging application on the mobile device 102 and communicating with another user running a messaging application on a personal computer. Further, note that in an actual implementation, many thousands of endpoints may be communicating with the server 104 at any given time, although in most situations, only small subsets of the endpoints (e.g., the devices of two or three users) will be communicating amongst each other.

In general, the server 104 includes a memory 220 and cache 222 in which messages are stored for each user. Note that for space considerations, messages may be discarded from the cache 222 for size and/or time reasons. For each mobile user running the messaging application 112 (FIG., 1), the page combiner logic 108 knows to retrieve the content sent by others for that user, and combine the content into a single set of data (corresponding to the page) before sending that page data to the user.

More particularly, it is more beneficial (faster) to aggregate content so as to download one page with as much content as possible than to split the content across several small pages. At the same time, the aggregation has to be conducted in such manner that the application program remains highly useable. For example, consider that downloading a page on a mobile device takes two seconds to establish a network connection, one second to locate the server, one second to request the page and one second to download a 10 kb page. Therefore, with these example times, downloading a 10 kb page will on average take five seconds, whereas downloading two 10 kb pages will take between eight and ten seconds (depending on whether the device suspended the connection after downloading the first page which happens after a period of inactivity, or whether the two pages were downloaded within a small interval of time).

However, when the page combiner logic 108 combines the content of the two example pages, the total download time is only six seconds, because the steps prior to downloading are executed only once per a downloaded page. Note that if the pages are fairly short and similar, the time will be even shorter because when two pages are combined together, the overhead (e.g., the HTML opening and closing tags, and/or HTML markup representing branding and navigational elements often present in the header and the footer of each page) are needed only once, so the total of two pages can be less than 20 kb.

Note that combining relatively static content (that does not change frequently over time) is straightforward, e.g., a single news article may be split into two pages or presented as one combined page. However, bi-directional communication with frequent changes as in messaging has other issues that need to be dealt with. As described herein, because of various aspects handled at the server and mobile messaging application, including the per-user information maintained in the memory 220 and cache 222, as well as the features of the mobile messaging application 112, bi-directional communication is now able to be conducted with multiple endpoints from one page, without compromising usability aspects of the communication.

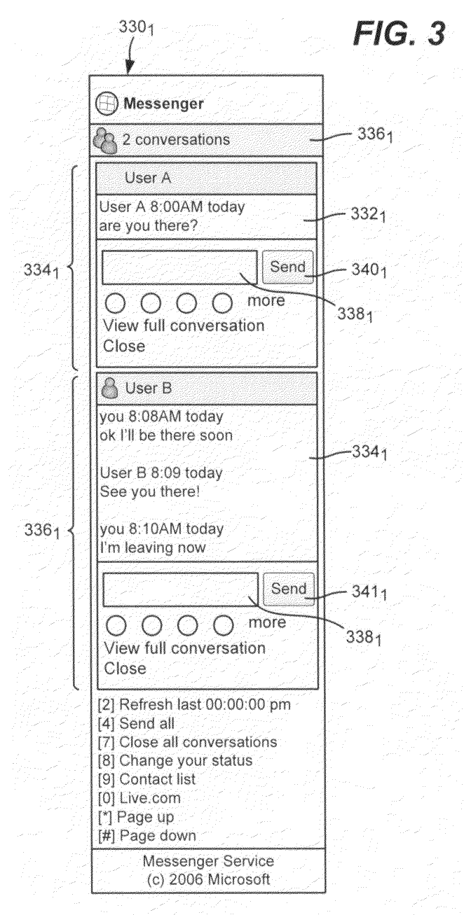

FIG. 3 shows an example combined output page 330₁ displaying content 332₁ and 334₁ corresponding to separate conversations from two different users, User A and User B, respectively. In one implementation, an indication 336₁ accompanying the application's rendering of the content 332₁ and 334₁ on the example output page 330₁ informs the user that the content from the two conversations are presently being displayed. For example, metadata accompanying the download provides the messaging application 112 with this “two conversation” information.

As represented in the example page 330₁, each conversation has its own interaction area, 334₁ and 336₁, respectively for User A and User B. The text of the conversation content 332₁ and 334₁ are in these areas 334₁ and 336₁ respectively, along with user input areas, such as text input areas 338₁ and 339₁, send buttons 340₁ and 341₁, selectable icons (the unlabeled circles below the a text input area 338₁) and a “more” selection, and selections for viewing the full conversation or closing the conversation. Note that the “more” selection allows the mobile messaging application 112 or alternatively (or in addition to) the server 104 to trim the amount of message content shown per conversation. Size, number of messages, and/or time data accompanying each message may be used to determine how much message content to show.

By receiving and maintaining identity information for each other user at the messaging application 112, the messaging application 112 allows the user to separately interact with each other user from the single page. For example, as represented in FIG. 3, the user can send a message to a given user A by entering text in the text input area 338₁ and actuating the send button 340₁. By including the identity information with the outgoing message, each message is routed by the server to the appropriate recipient. Note that via a keypad entry (e.g., “4” as listed below the area 336₁), a user can “Send all” and thereby send multiple messages to multiple recipients with a single command, with the server routing each message to each recipient.

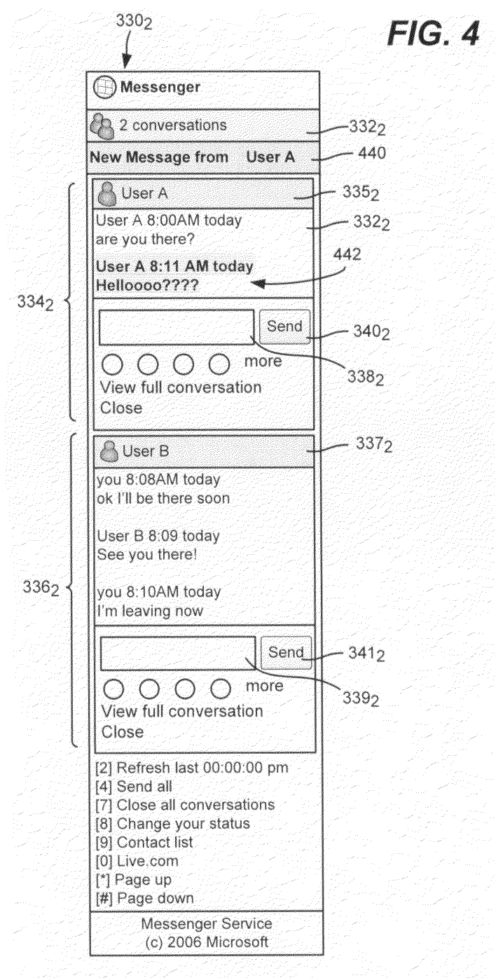

FIG. 4 shows a modified example page 330₂ that appears when the application 112 refreshes the page in some way, and there has been at least one change to the page data. Note that typically the application refreshes the page when refresh is requested by the user, but it is feasible to have a timer or the like request a refresh, to refresh based on information received from the server 104, and/or whenever the application is closed and restarted.

In FIG. 4, most of the page elements are unchanged from FIG. 3, and are labeled with subscript “2” instead of subscript “1” for purposes of highlighting their similarity except for appearing on a more recent page. However, note that in this example implementation, a new notification banner area 440 is present, to indicate to the user that a new message from User A is presently being displayed. This is because introducing more content on one page can be potentially confusing to the user. Further, note the new content comprising the new message text 442 in the now-enlarged content area 332₂.

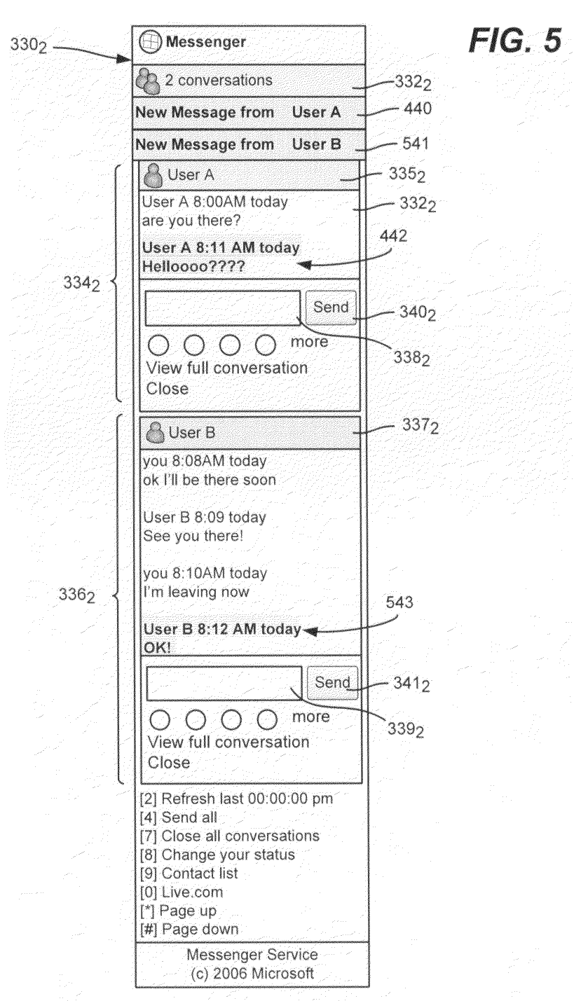

Similarly, the banner area in FIG. 5 (comprising two alerts/notifications, the alert 440 for user A and an alert 541 for User B) shows that sometime later, new message content 543 from User B is present and is being displayed. Note that in one example implementation, the alert 541 indicating that User B's has new content present is in the same banner area near the top of the page, e.g., below the User A new content alert 440, but above USER A's interactive area 3342. Choosing (e.g., interacting with) one of these alerts 440 or 541 will “jump” the user to that part of the page with that conversation, e.g., 334₂ or 336₂, respectively.

While in the black-and-white image of FIGS. 4 and 5 the notification banner 440 and/or 541 and text 442 and/or 542 are highlighted via bold text against grey backgrounds, it can be readily appreciated that colored text and/or backgrounds (or other visual mechanisms such as blinking and/or larger text) may better emphasize the notification (or notifications) and changed content. In one example implementation, every time the page is refreshed and message content has changed, the banner area 440 and/or 541 (FIG. 5) is updated to indicate which users sent new messages, and any new messages are highlighted with a different color.

To determine when a page has changed, the server 104 maintains the timestamps of messages maintained for a user and a timestamp of the last page load of that user. If the user requests a page, the timestamps of each message will indicate to the server any new message content since the last load, whereby a new message notification (e.g., for the mobile device's displayed area 440) and highlighted message content can be provided to the mobile device messaging application 112.

As described below, much of the functionality described herein may be performed at the server or at the mobile device's messaging application program, or by some combination of both. Note that the server knows when a mobile device's messaging application (e.g., versus a personal computer's messaging application) is requesting content, so the server at least knows to combine multiple conversation's messages into a single page, and may further format and/or otherwise modify some of the content accordingly, e.g., to change the page's appearance when rendered. Alternatively, the server may provide metadata along with the message content to the mobile device's messaging application so that the messaging application can locally format and/or modify the content's appearance prior to being rendered. Both alternatives are generally described herein, along with combinations thereof, and it can be readily appreciated that it is equivalent to adjust any of the page content at the server, at an endpoint, or via any combination of server and endpoint structure and/or functionality.

In addition to combining pages to facilitate faster times yet while maintaining usability, the application and/or server addresses usability implications of efficient, but potentially harder to interact-with longer pages. More particularly, if a page would become too large to navigate efficiently, a mechanism is provided to bring only the most important information to the user's attention. In a messaging scenario, the most recently changed conversations are considered the most important, and thus the mechanism collapses older conversations. Criteria to determine when to collapse one or more conversations may be an estimated or actual length, or based on the number of conversations that are open.

For example, in one example implementation, the oldest conversation or conversations get collapsed if there are already five open conversations, so that the message content of no more than five conversations are viewable on the page. While this makes interacting with older messages less convenient (interaction with the older messages are significantly slower due to the need to fetch the content and render it as a new page), collapsing older messages is generally more efficient because the user is more likely to interact with more recent active conversations than those that have not been active for a longer time.

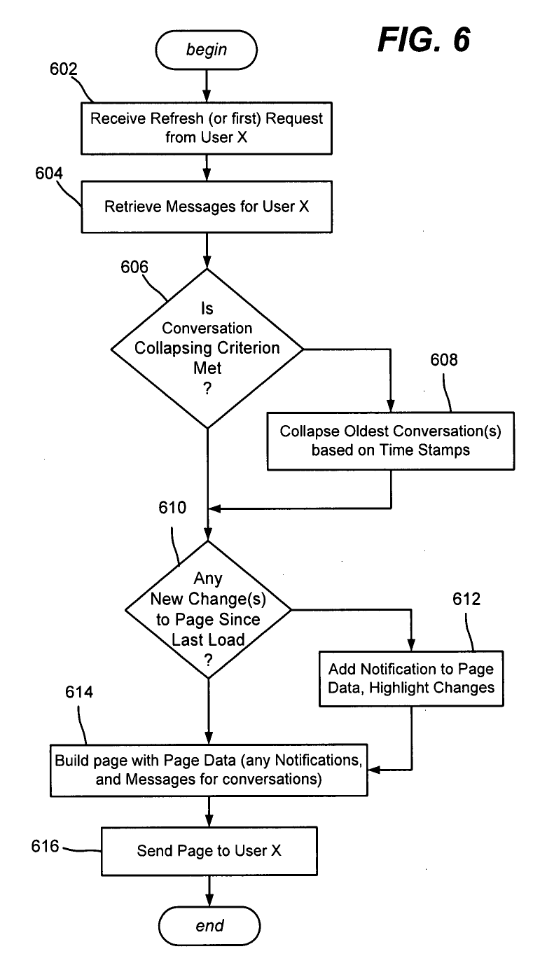

FIG. 6 is a flow diagram that summarizes various aspects and concepts described herein, beginning at step 602 when a mobile device corresponding to a User X requests a message content refresh (or provides a first request for content). Step 604 retrieves the messages for this User X from the memory 220/cache 222, from each of the various other endpoints (corresponding to other users' conversations) that have sent messaging content to this user.

As described above, when some collapsing criteria is met as evaluated by step 606, the server 104 can collapse the page data, as represented by step 608. For example, the server can simply not provide the message content for the oldest conversation or conversations beyond the maximum number (e.g., five) most-recently active conversations. Alternatively, the server 104 can provide the message content even for conversations that will be collapsed, whereby it is up to the mobile messaging application 112 to collapse the page. As can be readily appreciated, a tradeoff between longer downloads (if letting the mobile messaging application 112 collapse the page) versus slower accessibility (if collapsing the page at the server) is present. The amount of data to download may be a factor in having the server or the mobile messaging application 112 collapse the page.

Thus, steps 606 and 608 may be performed by the server 104, by the mobile messaging application 112, or by some combination thereof. For example, the server may send the page containing at least five conversations, and may send more conversation data up to some size limit, whereby it is up to the mobile messaging application 112 to collapse the page as needed to show a maximum of five conversations.

Step 610 of FIG. 6 represents the handling of possibly changed data, e.g., using timestamps to detect new messages since the last page load for the User X. If the data has changed, step 612 adjusts the page data in some way to provide a change notification, and to highlight the changes. Otherwise, step 612 is skipped. For example, via step 612, a notification banner can be inserted into the page content to be rendered, whereby the notification banner will appear when the page rendered on the mobile device. Alternatively, the page can be flagged such that the mobile application 112 will add the notification banner that identifies the source or sources of the new message or messages to the content when it is received.

Similarly, the message content to be rendered can be modified at the server 104 so that it will be highlighted when rendered. Alternatively, other metadata can indicate to the messaging application 112 that it should change the way it renders the new content. Having the mobile messaging application 112 modify the page appearance adds complexity to the mobile messaging application 112, but allows the user to locally customize the rendered appearance on the mobile device without requiring the server to store that user's notification and highlighting preferences.

Step 614 represents building the page at the server, which includes the combined message content for possibly multiple conversations, as well as any change notification for a new message. Step 616 represents sending the page to the user X's mobile device.

As is understood, the above approach to consolidating content into one page and allowing the user to interact with multiple parties via that page is especially beneficial in data-intense scenarios, such as in the case of a messaging application. Notwithstanding, the above-concepts can be easily extended to other bi-directional communication scenarios, such as editing multiple contact information from a single page.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a computing device, a system comprising:
an output mechanism;
an input mechanism; and
bidirectional communication logic coupled to the display and input mechanism, the bidirectional communication logic providing a user interface that via the output mechanism displays content that is received from at least two endpoints in a single page, and provides for user interaction with the single page via the input mechanism to selectively communicate data to any of the endpoints.

2. The system of claim 1 wherein the computing device comprises a mobile device.

3. The system of claim 1 further comprising, a page collapsing mechanism that limits the content displayed on the page.

4. The system of claim 1 wherein the bidirectional communication logic comprises a messaging application.

5. The system of claim 4 wherein the messaging application receives data corresponding to the single page from a messaging service, and wherein the messaging application sends the selectively communicated data to the messaging service for routing to a specified endpoint that is identified in conjunction with the data.

6. The system of claim 1 wherein the displayed content in the single page includes separate areas, each area corresponding to each endpoint from which content is received.

7. The system of claim 6 wherein the bidirectional communication logic comprises a messaging application, and wherein each separate area for each endpoint comprises an interactive area having the displayed content corresponding to a conversation with a messaging participant at an endpoint, and an input mechanism for sending a message to that messaging participant.

8. The system of claim 7 wherein the input mechanism comprises a text input area and a send mechanism.

9. The system of claim 7 further comprising, a page collapsing mechanism that limits the content displayed on the page based upon a number of conversations.

10. The system of claim 9 wherein the messaging application receives data corresponding to the single page from a messaging service, and wherein the page collapsing mechanism is implemented in the service, or implemented in the messaging application, or implemented in part in the service and in part in the messaging application.

11. The system of claim 1 further comprising a notification banner area in the user interface that provides an indication of when content has changed.

12. The system of claim 11 wherein the displayed content in the single page includes separate areas, each area corresponding to an endpoint from which content is received, wherein the notification banner area includes an alert provided for each endpoint having changed content, and wherein interaction with a selected alert moves the user to the area corresponding to that endpoint for which that alert is provided.

13. The system of claim 1 wherein the bidirectional communication logic comprises a messaging application, wherein the output mechanism displays message content, and further comprising a mechanism that changes the appearance of message content that has changed relative to previously displayed message content.

14. A computer-readable medium having computer-executable instructions, which when executed perform steps, comprising:
receiving message content from a plurality of senders, the message content directed towards a common recipient;
combining the message content into page data corresponding to a single page; and
sending the page data to the common recipient.

15. The computer-readable medium of claim 14 wherein sending the page data to the common recipient comprises constructing page data in response to a refresh request from the common recipient.

16. The computer-readable medium of claim 14 having further computer-executable instructions comprising, receiving other message content from the common recipient directed to a selected sender of the plurality of the senders, and routing the message content to the selected sender.

17. The computer-readable medium of claim 14 having further computer-executable instructions comprising, collapsing the page by limiting the message content based on collapsing one or more collapsing criteria.

18. The computer-readable medium of claim 17 wherein collapsing the page by limiting the message content based on collapsing one or more collapsing criteria comprises, limiting the message content to a limited number of conversations, limiting a total amount of content sent in the page data, or limiting the message content based on page size, or any combination of conversation limitation, content amount, or page size criteria.

19. In a computing device having a messaging application, a method comprising:
receiving page data including message content corresponding to a plurality of separate conversations;
outputting a visible representation of the page data as a single page, including displaying at least some of the message content that corresponds to at least two of the separate conversations;
receiving user input corresponding to an outgoing message directed towards a selected messaging participant that corresponds to one of the conversations; and
sending the outgoing message to the selected messaging participant, including providing data with the outgoing message that is useable for routing the output message to that participant.

20. The method of claim 19 wherein outputting the visible representation of the page data includes displaying message content in separate areas with each area corresponding to a separate conversation, and displaying at least one indication when message content has changed relative to previously displayed message content, including by providing a notification indication, or by changing the appearance of message content that has changed, or both by providing a notification indication and by changing the appearance of message content that has changed.
